(19) United States
(12) Patent Application Publication
(10) Pub. No.: US 2011/0054773 A1
(43) Pub. Date: Mar. 3, 2011

(54) Electronic Blind-Navigation Device and Electronic Blind-Navigation Cane having the same

(75) Inventors: Cheng-Jan CHI, Taipei (TW); Ren-Chyuan Luo, Taipei (TW); Chun-Chi Lai, Taipei (TW)

(73) Assignee: National Taiwan University

(21) Appl. No.: 12/649,334

(22) Filed: Dec. 30, 2009

(30) Foreign Application Priority Data
Aug. 28, 2009 (TW) 098129024

(51) Int. Cl. G01C 21/00

(52) U.S. Cl. 701/200

(57) ABSTRACT

An exemplary electronic blind-navigation device suitable for being arranged on a carrier includes an information receiving interface, a guiding interface, a direction detecting device and a processing circuit. The direction detecting device is configured for detecting a direction pointed by the carrier to obtain a pointing direction information. The processing circuit is configured for receiving the pointing direction information and a navigation information supplied from a navigation device. The navigation information includes a traveling direction information. The processing circuit is further configured for determining whether two directions supplied by the pointing direction information and the traveling direction information are the same. When the two directions thereof are the same, the processing circuit controls the guiding interface to send out at least one of a touch guiding signal and a voice guiding signal. Furthermore, an electronic blind-navigation cane having the same is also provided.

This application claims the priority benefit of Taiwan application serial no. 098129024, filed on Aug. 28, 2009.

### BACKGROUND

1. Field of the Invention

The present invention generally relates to an electronic blind-navigation technology and, more particularly, to a low-cost electronic blind-navigation device and an electronic blind-navigation cane having the same.

2. Description of Prior Art

With the development of technology, more and more electronic devices are widely used in people's lives. Since the visually impaired people need more help from the society, many manufacturers devote to the development of electronic blind-navigation device so that the visually impaired people can acquire navigation information by the electronic blind-navigation device instead of the traditional blind-navigation device.

Generally speaking, the current electronic blind-navigation device employs a voice guided GPS (global positioning system) to provide navigation information to the visually impaired people to guide them to walk to their desired destination. However, since the voice guided GPS is merely sensitive to the positions of people, the voice guided GPS needs to be moved to a predetermined distance to detect the real traveling direction of the visually impaired people. Thus, the visually impaired people rely less on such voice guided GPS to go out. To solve the aforementioned problem, some manufacturers design an electronic blind-navigation device so called an electronic blind-navigation dog. The electronic blind-navigation dog has a built-in navigator for providing navigation information, and a complex high-order processor for processing a variety of complex signals to simulate the behavior of the traditional blind-navigation dog to guide the visually impaired people. Since the electronic blind-navigation dog needs to employ the built-in navigator and the complex high-order processor, the cost of the electronic blind-navigation dog is so much that a common visually impaired people can not afford it. In addition, the weight and the volume of the electronic blind-navigation dog are increased because the integration of system is very complex. Thus, the electronic blind-navigation dog is difficult to be commercialized.

### BRIEF SUMMARY

The present invention relates to a low-cost electronic blind-navigation device.

The present invention further relates to an electronic blind-navigation cane corresponding to the electronic blind-navigation device.

The present invention provides an electronic blind-navigation device suitable for being arranged on a carrier. The electronic blind-navigation device includes an information receiving interface, a guiding interface, a direction detecting device and a processing circuit. The direction detecting device is configured for detecting a direction pointed by the carrier to obtain a pointing direction information. The processing circuit is configured for receiving the pointing direction information and receiving a navigation information supplied from a navigation device through the information receiving interface. The navigation information includes a traveling direction information. The processing circuit is further configured for determining whether two directions supplied by the pointing direction information and the traveling direction information are the same. When the two directions thereof are the same, the processing circuit controls the guiding interface to send out at least one of a touch guiding signal and a voice guiding signal.

The present invention further provides an electronic blind-navigation cane comprising a walking cane and an electronic blind-navigation device. The electronic blind-navigation device is arranged on the walking cane. The electronic blind-navigation device is configured for detecting a direction pointed by the walking cane to obtain a pointing direction information and for receiving a navigation information supplied from a navigation device. The navigation information includes a traveling direction information. The electronic blind-navigation device is further configured for determining whether two directions supplied by the pointing direction information and the traveling direction information are the same. When the two directions are the same, the electronic blind-navigation device sends out at least one of a touch guiding signal and a voice guiding signal.

In an exemplary embodiment, the guiding interface supplies the touch guiding signal by a needle pointer or a vibrating mode.

In an exemplary embodiment, the information receiving interface is a wired interface or a wireless interface.

In an exemplary embodiment, the direction detecting device is an electronic compass, a magnetic compass or a gyroscope.

In an exemplary embodiment, the navigation device is a GPS, a mobile phone with a navigation function or a personal digital assistant with a navigation function. In addition, the navigation device is an acoustic control navigation device.

In the present invention, the electronic blind-navigation device employs the direction detecting device thereof to detect the direction pointed by the carrier to obtain a pointing direction information. In addition, the said electronic blind-navigation device further employs the processing circuit thereof to determine whether two directions supplied by the pointing direction information and the traveling direction information are the same. When the two directions thereof are the same, the processing circuit controls the guiding interface to send out at least one of a touch guiding signal and a voice guiding signal to prompt the visually impaired people a right traveling direction. Thus, the degree of the traveling difficulty of guiding the visually impaired people to their desired destination may be effectively reduced.

The electronic blind-navigation device of the present invention employs a traditional navigation device to provide a navigation information that does not include any special built-in navigation devices. Since the processing circuit in the electronic blind-navigation device just needs to process the pointing direction information and the navigation information, and need not process a variety of complex signals, the electronic blind-navigation device does not require any complex high-order processors. Therefore, the cost of the electronic blind-navigation device is low, and most of the visually impaired people can afford it.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of an electronic blind-navigation device in accordance with an exemplary embodiment of the present invention;

FIG. 2 is a schematic view of an electronic blind-navigation cane in accordance with an exemplary embodiment of the present invention.

### DETAILED DESCRIPTION

### First Embodiment

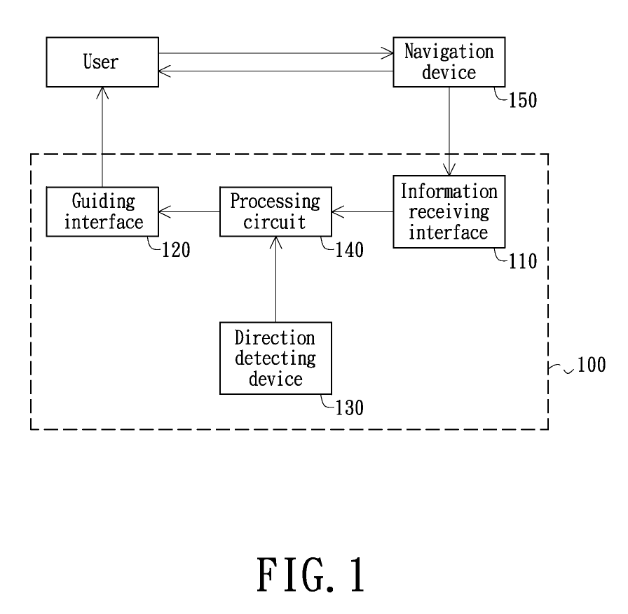

FIG. 1 shows an electronic blind-navigation device in accordance with an exemplary embodiment of the present invention. In FIG. 1, the label 100 represents the said electronic blind-navigation device. The electronic blind-navigation device 100 is suitable for being arranged on a carrier. For example, the electronic blind-navigation device 100 can be arranged on a stick-shaped object. The electronic blind-navigation device 100 comprises an information receiving interface 110, a guiding interface 120, a direction detecting device 130 and a processing circuit 140.

The direction detection device 130 is configured for detecting a direction pointed by the carrier to obtain a pointing direction information. The processing circuit 140 is electrically connected to the information receiving interface 110, the guiding interface 120 and the direction detecting device 130. The processing circuit 140 is configured for receiving the pointing direction information from the direction detection device 130 and for receiving a navigation information supplied by the navigation device 150 through the information receiving interface 110. Wherein, the navigation information includes a traveling routes information and a traveling direction information. In addition, the processing circuit 140 is further configured for determining whether two directions supplied by the pointing direction information and the traveling direction information are the same. When the two directions thereof are the same, the processing circuit 140 controls the guiding interface 120 to send out at least one of a touch guiding signal and a voice guiding signal. For example, the guiding interface 120 may include a needle pointer, a vibrating device and a loudspeaker, so the guiding interface 120 can employ the needle pointer or the vibrating device to provide a touch guiding signal or employ the loudspeaker to generate a voice as a voice guiding signal.

In the embodiment, the information receiving interface 110 can be implemented by a wired interface or a wireless interface. The direction detection device 130 can be implemented by an electronic compass, a magnetic compass or a gyroscope. In addition, the navigation device 150 can be a GPS, a mobile phone with a navigation function or a PDA (personal digital assistant) with a navigation function. Preferably, the navigation device 150 can be implemented by an acoustic control navigation device, so that the visually impaired people may conveniently input commands to the navigation device 150. For example, the visually impaired people may input a desired destination to the navigation device 150 by using voice, so as to enable the navigation device 150 to feedback a corresponding operating indication and a corresponding navigation information.

Thus, when the visually impaired people wiggle the carrier (such as a stick-shaped object) to the left and right, the direction detecting device 130 of the electronic blind-navigation device 100 detects the direction pointed by the carrier along the wiggle of the carrier instantly, and the direction detecting device 130 generates a corresponding pointing direction information to be processed by the processing circuit 140. If the processing circuit 140 determines the two directions supplied by the pointing direction information and the traveling direction information of the navigation information are the same, the processing circuit 140 controls the guiding interface 120 to send out at least one of a touch guiding signal and a voice guiding signal to prompt the visually impaired people that the direction pointed by the carrier is the traveling direction supplied by the navigation information. Thus, the visually impaired people may move on according to the direction pointed by the carrier and need not worry about disorientation.

Further, the processing circuit 140 may determine whether the traveling direction of the visually impaired people have yawed according to the pointing direction information and the traveling direction information. When the traveling direction of the visually impaired people have yawed, the processing circuit 140 controls the guiding interface 120 to send out a direction yawing alarm to notify the visually impaired people. Certainly, the processing circuit 140 can also determine whether the visually impaired people are at an intersection (such as a crossroad or a T-crossing) according to the traveling routes information and the traveling direction information of the above navigation information and the pointing direction information. When the visually impaired people are at an intersection, the processing circuit 140 controls the guiding interface 120 to send an alarm to the visually impaired people.

### Second Embodiment

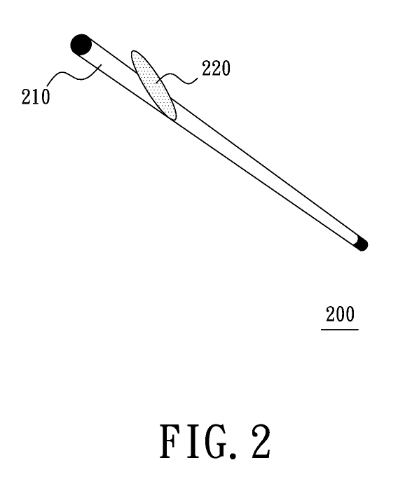

FIG. 2 illustrates an electronic blind-navigation cane in accordance with an exemplary embodiment of the present invention. As illustrated in FIG. 2, the electronic blind-navigation cane 200 includes a walking cane 210 and an electronic blind-navigation device 220 of the present invention. The electronic blind-navigation device 220 is arranged on the walking cane 210 for detecting the direction pointed by the walking cane 210 to obtain a pointing direction information. The electronic blind-navigation device 220 is also configured for receiving a navigation information supplied by a navigation device. The navigation information includes a traveling direction information. The electronic blind-navigation device 220 is further configured for determining whether two directions supplied by the pointing direction information and the traveling direction information are the same. When the two directions thereof are the same, the electronic blind-navigation device 220 sends out at least one of a touch guiding signal and a voice guiding signal.

To sum up, the electronic blind-navigation device of the present invention employs the direction detecting device thereof to detect the direction pointed by the carrier to obtain a pointing direction information. In addition, the said electronic blind-navigation device further employs the processing circuit thereof to determine whether two directions supplied by the pointing direction information and the traveling direction information are the same. When the two directions thereof are the same, the processing circuit controls the guiding interface to send out at least one of a touch guiding signal and a voice guiding signal to prompt the visually impaired people a right traveling direction. Thus, the degree of the traveling difficulty of guiding the visually impaired people to their desired destination can be effectively reduced.

The electronic blind-navigation device of the present invention employs a traditional navigation device to provide a navigation information and does not have any special built-in navigation devices. Since the processing circuit in the electronic blind-navigation device just needs to process the pointing direction information and the navigation information and need not process a variety of complex signals, the electronic blind-navigation device does not require any complex high-order processors. Therefore, the cost of the electronic blind-navigation device is low, and most of the visually impaired people can afford it.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electronic blind-navigation device suitable for being arranged on a carrier, comprising:
an information receiving interface;
a guiding interface;
a direction detecting device configured for detecting a direction pointed by the carrier to obtain a pointing direction information; and
a processing circuit configured for receiving the pointing direction information and receiving a navigation information supplied from a navigation device through the information receiving interface, the navigation information including a traveling direction information, the processing circuit being further configured for determining whether two directions supplied by the pointing direction information and the traveling direction information are the same, wherein when the two directions thereof are the same, the processing circuit controlling the guiding interface sends out at least one of a touch guiding signal and a voice guiding signal.

2. The electronic blind-navigation device as claimed in claim 1, wherein the guiding interface supplies the touch guiding signal by a needle pointer or a vibrating mode.

3. The electronic blind-navigation device as claimed in claim 1, wherein the information receiving interface is a wired interface or a wireless interface.

4. The electronic blind-navigation device as claimed in claim 1, wherein the direction detecting device is an electronic compass, a magnetic compass or a gyroscope.

5. The electronic blind-navigation device as claimed in claim 1, wherein the navigation device is a GPS, a mobile phone with a navigation function or a personal digital assistant with a navigation function.

6. The electronic blind-navigation device as claimed in claim 1, wherein the navigation device is an acoustic control navigation device.

7. An electronic blind-navigation cane, comprising:
a walking cane; and
an electronic blind-navigation device arranged on the walking cane, the electronic blind-navigation device being configured for detecting a direction pointed by the walking cane to obtain a obtain a pointing direction information and for receiving a navigation information supplied from a navigation device, the navigation information including a traveling direction information, the electronic blind-navigation device being further configured for determining whether two directions supplied by the pointing direction information and the traveling direction information are the same, wherein when the two directions are the same, the electronic blind-navigation device sends out at least one of a touch guiding signal and a voice guiding signal.

8. The electronic blind-navigation cane as claimed in claim 8, wherein the electronic blind-navigation device comprises:
an information receiving interface;
a guiding interface;
a direction detecting device configured for detecting a direction pointed by the walking cane to obtain a pointing direction information; and
a processing circuit configured for receiving the pointing direction information and a navigation information supplied from a navigation device through the information receiving interface, the processing circuit being further configured for determining whether two directions supplied by the pointing direction information and the traveling direction information are the same, wherein when the two directions thereof are the same, the processing circuit controls the guiding interface to send out at least one of a touch guiding signal and a voice guiding signal.

9. The electronic blind-navigation cane as claimed in claim 8, wherein the guiding interface supplies the touch guiding signal by a needle pointer or a vibrating mode.

10. The electronic blind-navigation cane as claimed in claim 8, wherein the information receiving interface is a wired interface or a wireless interface.

11. The electronic blind-navigation cane as claimed in claim 8, wherein the direction detecting device is an electronic compass, a magnetic compass or a gyroscope.

12. The electronic blind-navigation cane as claimed in claim 8, wherein the navigation device is a GPS, a mobile phone with a navigation function or a personal digital assistant with a navigation function.

13. The electronic blind-navigation cane as claimed in claim 8, wherein the navigation device is an acoustic control navigation device.
